(19) United States
(12) Patent Application Publication
(10) Pub. No.: US 2024/0359731 A1
(43) Pub. Date: Oct. 31, 2024

(54) HYDRAULIC STEERING SYSTEM

(71) Applicant: Danfoss Power Solutions ApS, Nordborg (DK)

(72) Inventor: Emil Nørregard Olesen, Nordborg (DK)

(21) Appl. No.: 18/645,993

(22) Filed: Apr. 25, 2024

(30) Foreign Application Priority Data
Apr. 27, 2023 (DE) 102023110880.8

(51) Int. Cl. B62D 5/08; B62D 5/06; B62D 5/09

(52) U.S. Cl. CPC B62D 5/08; B62D 5/062; B62D 5/09

(57) ABSTRACT

A hydraulic steering system (1) including a supply port arrangement having a supply port (P) and a return port (T), a working port arrangement having two working ports (L, R), and a measuring motor (4). The steering behavior of such a steering system should be improved. To this end for each steering direction the measuring motor (4) is arranged in flow direction between the working port (L, R) and the return port (T).

### CROSS-REFERENCE TO RELATED APPLICATION

This application claims foreign priority benefits under 35 U.S.C. § 119 to German Patent Application No. 102023110880.8 filed on Apr. 27, 2023, the content of which is hereby incorporated by reference in its entirety.

### TECHNICAL FIELD

The present invention relates to a hydraulic steering system comprising a supply port arrangement having a supply port and a return port, a working port arrangement having two working ports, an orifice arrangement, and a measuring motor.

### BACKGROUND

Such a steering system is used to steer a vehicle. For steering the vehicle, the driver of the vehicle activates a steering command device, for example a steering wheel, wherein some orifices of the orifice arrangement are opened, and other orifices are closed. Hydraulic fluid from the supply port is directed to one of the working ports and from there to a steering motor, for example a steering cylinder. The orifice arrangement is in many cases embodied in a spool/sleeve set, wherein upon rotation of the steering wheel the spool and the sleeve of the spool/sleeve set are rotated in relation to each other. In a conventional system the hydraulic fluid flowing to the working port drives the measuring motor which restores spool and sleeve to their neutral position.

Due to internal leakages in such a system a drift occurs so that the angular position of the steering wheel and the steering direction of the steered vehicle no longer match.

### SUMMARY

The object underlying the present invention is to improve the steering behavior.

This object is solved with the hydraulic steering system as described at the outset in that for each steering direction the measuring motor is arranged in flow direction between the working port and the return port.

In such a steering system the return flow is metered out or measured for both steering directions. This means that in both flow directions the measuring motor is operated at a lower pressure. The lower the pressure the lower the losses produced by leakages in the measuring motor. Furthermore, a pressure drop between the supply port and the respective working port, i.e., the working port from which hydraulic fluid is supplied to a steering motor, can be reduced, since the high pressure is no longer going through the commutation system. This means that the system can be operated at the lower pressure level and with the lower energy consumption.

In an embodiment of the invention for each steering direction one of the working ports is connected to the supply port via a main flow path comprising a main orifice and a supply path comprising a first orifice. The hydraulic flow is no longer directed through the measuring motor, but more or less directly connected to the supply port. During steering the main orifice and the first orifice are usually open and produce only a small pressure drop, so that basically the pressure at the supply port can be used to operate the steering motor.

In an embodiment of the invention for each steering direction the other of the working ports is connected to the return port via a return path comprising a second orifice and the measuring motor. Hydraulic fluid flowing through the second orifice produces a pressure drop so that the measuring motor is loaded with a pressure lower than the pressure at the respective working port. Thus, wear of and leakages in the measuring motor can be kept low.

In an embodiment of the invention for each steering direction the return path is provided with a third orifice and a fourth orifice arranged one behind the other in flow direction. The third orifice can belong to one steering direction and the fourth orifice can belong to the other steering direction. Thus, the orifice arrangement which is known from conventional steering units and having two measuring motor orifices and two working port orifices can basically still be used. It is only necessary to change the order of the orifices in the flow path.

In an embodiment of the invention in a neutral position the two first orifices are at least partly open and are connected to a load sensing port. In this case it is possible to hold a pressure at both working ports which is the same for the two working ports and which is at an elevated level. Thus, the steering motor connected to the working ports is pretensioned or “clamped” between the elevated pressures at the two working ports which increases the stiffness of the steering motor. This feature is of advantage in particular in connection with articulated vehicles so that these vehicles can be driven with a higher speed and the risk of instability of the steering behavior is kept low.

In an embodiment of the invention the load sensing port is connected to pressure control means controlling a pressure at the supply port. This means that in the neutral position the two first orifices are supplied with a pressure which is already available in the steering system and which depends on the actual load situation.

In an embodiment of the invention the pressure control means are in form of a priority valve. The priority valve has the advantage that in periods in which no steering is necessary the hydraulic fluid can be used for other purposes.

In an embodiment of the invention a point upstream the two first orifices is connected to the return port via a drain orifice. In the neutral position of the steering system pressure upstream the drain orifice is then supplied to the two working ports.

In an embodiment of the invention a controlled closing valve is arranged upstream the return port. When the closing valve is closed, fluid can no longer escape to the return port and from there to a tank. This means that the rest of the steering system forms a closed circuit, so that the measuring motor can be used as an auxiliary steering pump and emergency steering is possible.

In an embodiment of the invention the closing valve is controlled by a pressure derived from a pressure at the supply port. The closing valve closes automatically when the pressure at the supply port decreases below the level which is necessary for steering.

### BRIEF DESCRIPTION OF THE DRAWINGS

An embodiment of the invention will now be described with reference the drawing, in which:

FIG. 1 schematically shows a steering system,

FIG. 2 schematically shows the steering system in a mode for left steering,

FIG. 3 schematically shows the steering system in a neutral position, and

FIG. 4 schematically shows the steering system in a mode for right steering.

### DETAILED DESCRIPTION

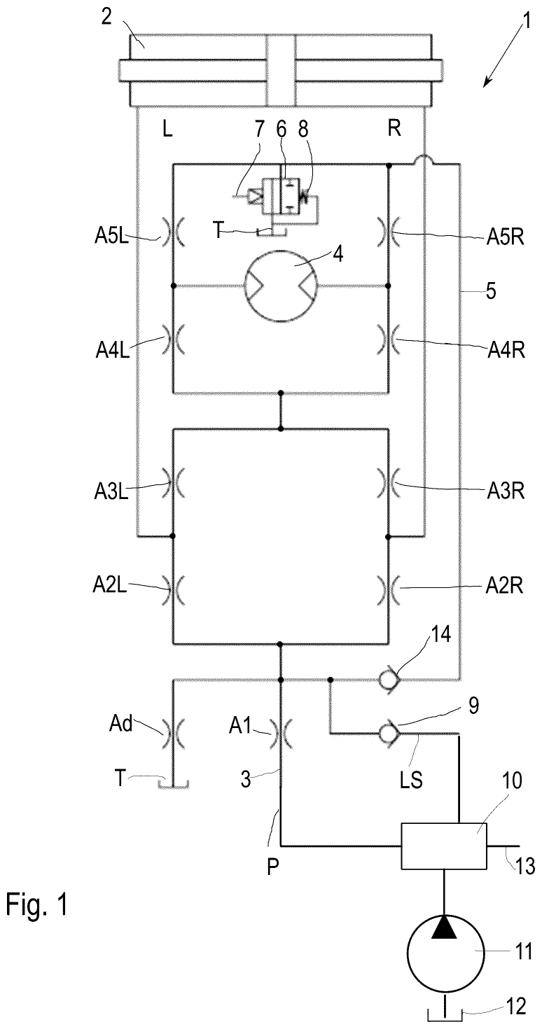

FIG. 1 schematically shows parts of the hydraulic steering system 1. The steering system 1 comprises a pressure port P, a return port T, wherein the pressure port P and the return port T together form a supply port arrangement. Furthermore, the steering system 1 comprises two working ports L, R forming a working port arrangement to which a steering motor 2 can be connected.

The steering system 1 comprises a main flow path 3 in which a main orifice Al is arranged. Furthermore, the steering system 1 comprises for each steering direction a first orifice A2L, A2R, a second orifice A3L, A3R, a third orifice A4L, A4R, and a fourth orifice A5L, A5R. A measuring motor 4 is connected between a first point connecting the third and fourth left orifices A4L, A5L on the one hand and a second point connecting the third and fourth right orifices A4R, A5R on the other hand.

The fourth orifices A5L, A5R are connected to the return line 5. The return line 5 is connected to the return port T by means of the controlled closing valve 6. The closing valve 6 comprises a control input 7 which is connected in a way not shown to the supply port P. The closing valve 6 comprises a spring 8. When a force produced by the pressure at the control input 7 is larger than a force produced by the spring 8 the control valve 6 is open. When the force produced by the pressure at the control input 7 does not exceed the force produced by the spring 8 the control valve 6 is closed and interrupts a connection between the return line 5 and the return port T.

The left working port L is connected to a point between the first and second left orifices A2L, A3L. The right working port R is connected to a point between the first and second right orifices A2R, A3R. The second left orifice A3L and the second right orifice A3R are connected to a point connecting the third left orifice A4L and the third right orifice A4R.

The main flow path 3 is connected to the return port T by means of a drain orifice Ad. The return line 5 is connected to the drain orifice Ad via a check valve 14. The main flow path 3 is also connected to a load sensing port LS which is connected via a check valve 9 to a priority valve 10. The priority valve 10 receives hydraulic fluid from a pump 11 which sucks hydraulic fluid from a tank 12 or another container. A priority output of the priority valve 10 is connected to the pressure port P. The priority valve 10 comprises a second output 13 which can be connected to another working hydraulic.

The orifices A1, A2L, A2R, A3L, A3R, A4L, A4R, A5L, A5R, and Ad form an orifice arrangement which is realized by a spool/sleeve set. The spool/sleeve set comprises a spool and a sleeve surrounding the spool wherein the spool/sleeve set is rotatably arranged in a bore of a housing and the spool and the sleeve are rotatably in relation to each other. When the spool is rotated in relation to the sleeve, for example due to the action of the steering wheel, some of the orifices are opened and other orifices are closed depending on the desired steering direction. As will be explained below, hydraulic fluid is supplied to one of the working ports L, R and actuates the steering motor 2. Hydraulic fluid displaced by the steering motor 2 flows back through the other working port R, L and through the measuring motor 4 and drives the measuring motor 4. The measuring motor 4 is connected to the sleeve and restores the sleeve back to the neutral position once the necessary amount or a volume of hydraulic fluid has been supplied to the steering motor 2. This means that orifices which have previously been opened are again closed and orifices which have previously been closed again are opened.

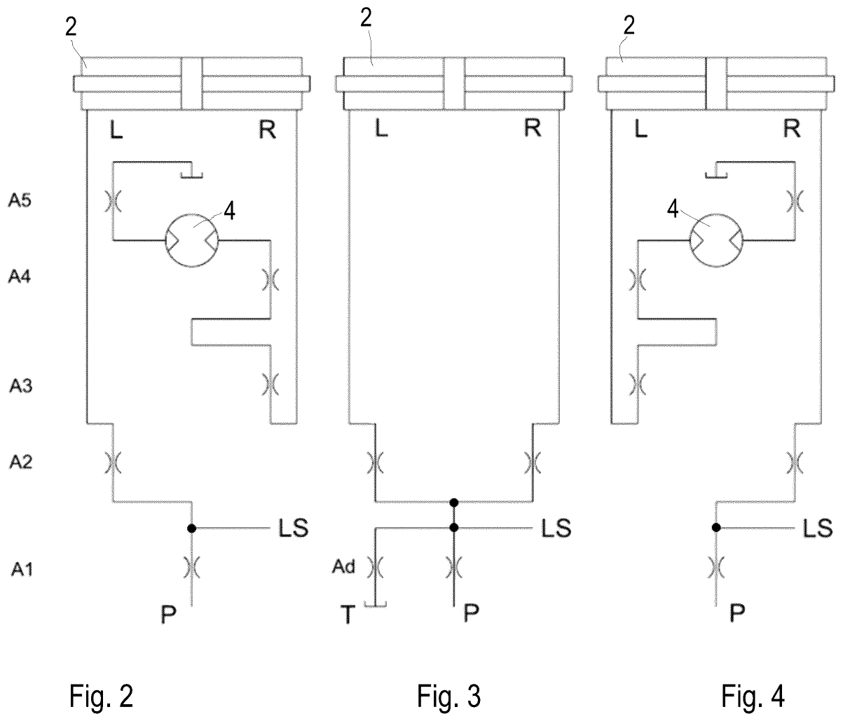

FIG. 2 to 4 show which of the orifices are open when steering to the left or right or when in neutral position. In order to simplify the explanation, only orifices which are open are shown and the first to fifth orifices are denoted in the column on the left-hand side of the drawing sheet only. The identification which orifice is a left orifice or a right orifice is made by the headline “L” or “R”. In all Fig. the same elements are denoted with the same reference numerals. The closing valve 6 is omitted. The closing valve 6 is an optional feature. It can, however, be used in the steering system shown in FIG. 2 to 4 as well.

FIG. 2 shows steering to the left. In this case the left pressure chamber of steering motor 2 connected to the left working port L should be pressurized by supplying hydraulic fluid from the supply port to the left working port L. To this end the main orifice Al and the left first orifice A2L is open, so that hydraulic fluid flows basically unrestricted to the left working port L and the left chamber of the steering motor 2.

Hydraulic fluid which is displaced from the right pressure chamber of the hydraulic motor 2 flows to the right working port R and through the second right orifice A3R, the third right orifice A4R, the measuring motor 4 and the fourth left orifice A5L to the return port T.

This means that the volume or flow of the hydraulic fluid returning from the steering motor 2 is metered out or measured by the measuring motor 4. This hydraulic fluid is on a lower pressure than the pressure at the supply port P. Thus, leakages in the measuring motor 4 can be reduced. Furthermore, since the pressure drop between the supply port P and the left working port L is smaller than in the case with a measuring motor arranged in between, a smaller supply pressure is sufficient for steering so that energy can be efficiently used.

FIG. 3 shows the situation in the neutral position. Both first orifices A2L, A2R and the main orifice Al are open. The drain orifice Ad is open as well, however forms a flow resistance. The pressure between the main orifice Al and the drain orifice Ad which corresponds to the load sensing pressure at the load sensing port LS is supplied to the two first orifices A2L, A2R and, since there is basically no flow to the steering motor 2, to the left working port L at the right working port R. The steering motor 2 is then pretensions or “clamped” between two equal pressures which makes the steering motor 2 stiffer and increases stability in the steering behavior of the vehicle to be steered by the steering motor 2. Furthermore, a faster steering response is achieved when steering starts out of neutral.

FIG. 4 shows steering to the right. Hydraulic fluid from the supply port P flows through the main orifice Al and the first right orifice A2R to the right working port R. Again, this flow is only restricted by the two orifices mentioned and not by the measuring motor 4, so that a large part of the pressure at the supply port P can reach the right working port R. Hydraulic fluid displaced from the left working chamber of the steering motor 2 to the left working port L flows through the second left orifice A3L, the third left orifice A4L, the steering motor 4, and the fourth right orifice A5R to the return port P. Again, the return flow of hydraulic fluid from the steering motor 2 is controlled by metering it out with the measuring motor 4.

It should be noted that the steering system 1 can have more than the shown elements, for example back pressure valves and spring-loaded suction valves for end stop torque. However, these elements are not shown to keep the illustration simple.

The present tensioning of the steering motor 2 in neutral position, as shown in FIG. 3, is an optional feature. It is in particular advantages when using the steering system in an articulated vehicle, since such a vehicle equipped with a conventional steering system shows an instable steering behavior when speed is increased, for example during road driving. Improving the torsional stiffness around the articulate or hinge point can be achieved by pretensioning the steering motor 2 in neutral position as shown in FIG. 3.

Since the return flow is guided through the measuring motor 4, kickback can be avoided. The load sensing port LS is not connected to the measuring motor 4. Furthermore, drift between the steering motor 2 and the steering wheel can be reduced or avoided.

The orifices A1, A2L, A2R, A3L, A3R, A4L, A4R, A5L, ASR, Ad forming the orifice arrangement are basically known from conventional steering units. However, the hydraulic fluid flows through these orifices in a different order, so that the return flow can be metered out by the measuring motor 4.

While the present disclosure has been illustrated and described with respect to a particular embodiment thereof, it should be appreciated by those of ordinary skill in the art that various modifications to this disclosure may be made without departing from the spirit and scope of the present disclosure.

1. A hydraulic steering system comprising a supply port arrangement having a supply port and a return port, a working port arrangement having two working ports, an orifice arrangement, and a measuring motor, wherein for each steering direction the measuring motor is arranged in flow direction between the working port and the return port.

2. The hydraulic steering system according to claim 1, wherein for each steering direction one of the working ports is connected to the supply port via a main flow path comprising a main orifice and a supply path comprising a first orifice.

3. The hydraulic steering system according to claim 2, wherein for each steering direction the other of the working ports is connected to the return port via a return path comprising a second orifice and the measuring motor.

4. The hydraulic steering system according to claim 3, wherein for each steering direction the return path is provided with a third orifice and a fourth orifice arranged one behind the other in flow direction.

5. The hydraulic steering system according to claim 2, wherein in a neutral position the two first orifices are at least partly open and are connected to a load sensing port.

6. The hydraulic steering system according to claim 5, wherein the load sensing port is connected to pressure control means controlling a pressure at the supply port.

7. The hydraulic steering system according to claim 7, wherein the pressure control means are in form of a priority valve.

8. The hydraulic steering system according to claim 5, wherein a point upstream the two first orifices is connected to the return port via a drain orifice.

9. The hydraulic steering system according to claim 1, wherein a controlled closing valve is arranged upstream the return port.

10. The hydraulic steering system according to claim 9, wherein the closing valve is controlled by a pressure derived from a pressure at the supply port.

11. The hydraulic steering system according to claim 3, wherein in a neutral position the two first orifices are at least partly open and are connected to a load sensing port.

12. The hydraulic steering system according to claim 4, wherein in a neutral position the two first orifices are at least partly open and are connected to a load sensing port.

13. The hydraulic steering system according to claim 6, wherein a point upstream the two first orifices is connected to the return port via a drain orifice.

14. The hydraulic steering system according to claim 7, wherein a point upstream the two first orifices is connected to the return port via a drain orifice.
